(19) United States
(12) Patent Application Publication
(10) Pub. No.: US 2026/0292926 A1
(43) Pub. Date: Sep. 24, 2026

(54) METHOD AND DEVICE FOR NETWORK ENERGY SAVING AND CONFIGURED UPLINK GRANT-BASED TRANSMISSION AND RECEPTION IN WIRELESS COMMUNICATION SYSTEM

(71) Applicant: LG ELECTRONICS INC., Seoul (KR)

(72) Inventors: Youngdae LEE, Seoul (KR); Seonwook KIM, Seoul (KR); Suckchel YANG, Seoul (KR); Sechang MYUNG, Seoul (KR)

(73) Assignee: LG ELECTRONICS INC., Seoul (KR)

(21) Appl. No.: 19/473,055

(22) PCT Filed: Apr. 5, 2024
(86) PCT No.: PCT/KR2024/004499

§ 371 Date: Oct. 6, 2025

(30) Foreign Application Priority Data
Apr. 6, 2023 (KR) 10-2023-0045679

(51) Int. Cl. H04W 76/28; H04L 5/00

(52) U.S. Cl. CPC H04W 76/28; H04L 5/0044

(57) ABSTRACT

A method performed by a terminal according to an embodiment of the present disclosure may comprise receiving information related to a configured uplink grant from a network; receiving, from the network, information related to one or more of cell discontinuous transmission (DTX) and cell discontinuous reception (DRX) of a serving cell; on the basis that the serving cell is within a cell DRX active period, performing new transmission or a retransmission of a transport block (TB) on the basis of the configured uplink grant, wherein no TB is generated in a medium access control (MAC) layer of the terminal and no TB retransmission is performed on the basis that the serving cell is not in the cell DRX active period.

### CROSS-REFERENCE TO RELATED APPLICATIONS

This application is the National Stage filing under 35 U.S.C. 371 of International Application No. PCT/KR2024/004499, filed on Apr. 5, 2024, which claims the benefit of earlier filing date and right of priority to Korean Application No. 10-2023-0045679, filed on Apr. 6, 2023, the contents of which are all hereby incorporated by reference herein in their entirety.

### TECHNICAL FIELD

The present disclosure relates to a wireless communication system, and in more detail, relates to a network energy saving and configured uplink grant-based transmission and reception method and device in a wireless communication system.

### BACKGROUND

A mobile communication system has been developed to provide a voice service while guaranteeing mobility of users. However, a mobile communication system has extended even to a data service as well as a voice service, and currently, an explosive traffic increase has caused shortage of resources and users have demanded a faster service, so a more advanced mobile communication system has been required.

The requirements of a next-generation mobile communication system at large should be able to support accommodation of explosive data traffic, a remarkable increase in a transmission rate per user, accommodation of the significantly increased number of connected devices, very low End-to-End latency and high energy efficiency. To this end, a variety of technologies such as Dual Connectivity, Massive Multiple Input Multiple Output (Massive MIMO), In-band Full Duplex, Non-Orthogonal Multiple Access (NOMA), Super wideband Support, Device Networking, etc. have been researched.

### SUMMARY

The technical problem of the present disclosure is to provide a configured uplink grant-based transmission and reception method and device in a wireless communication system to which network energy saving (NES) is applied.

The technical problem of the present disclosure is to provide a method and a device for processing configured uplink grant-based retransmission in a wireless communication system to which NES is applied.

The technical objects to be achieved by the present disclosure are not limited to the above-described technical objects, and other technical objects which are not described herein will be clearly understood by those skilled in the pertinent art from the following description.

A method performed by a terminal in a wireless communication system according to an aspect of the present disclosure may include receiving information related to a configured uplink grant from a network; receiving, from the network, information related to at least one of cell discontinuous transmission (DTX) or cell discontinuous reception (DRX) of a serving cell; based on the serving cell being within a cell DRX active period, performing new transmission of a transport block (TB) based on the configured uplink grant, wherein a TB is not generated in a medium access control (MAC) layer of the terminal based on the serving cell not being in a cell DRX active period; on a physical downlink control channel (PDCCH), receiving, from the network, an uplink grant related to retransmission of the TB; and based on the serving cell being within a cell DRX active period, performing retransmission of the TB based on an uplink grant related to retransmission of the TB, wherein based on the serving cell not being in a cell DRX active period, retransmission of the TB may not be performed in a physical (PHY) layer of the terminal.

A method performed by a base station in a wireless communication system according to an additional aspect of the present disclosure may include transmitting information related to a configured uplink grant to a terminal; transmitting, to the terminal, information related to at least one of cell discontinuous transmission (DTX) or cell discontinuous reception (DRX) of a serving cell; based on the serving cell being within a cell DRX active period, receiving new transmission of a transport block (TB) from the terminal based on the configured uplink grant, wherein a TB is not generated in a medium access control (MAC) layer of the terminal based on the serving cell not being in a cell DRX active period; on a physical downlink control channel (PDCCH), transmitting, to the terminal, an uplink grant related to retransmission of the TB; and based on the serving cell being within a cell DRX active period, receiving retransmission of the TB from the terminal based on an uplink grant related to retransmission of the TB, wherein based on the serving cell not being in a cell DRX active period, retransmission of the TB may not be performed in a physical (PHY) layer of the terminal.

According to the present disclosure, a configured uplink grant-based transmission and reception method and device in a wireless communication system to which network energy saving (NES) is applied may be provided.

According to the present disclosure, a method and a device for processing configured uplink grant-based retransmission in a wireless communication system to which NES is applied may be provided.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a structure of a wireless communication system to which the present disclosure may be applied.

FIG. 2 illustrates a frame structure in a wireless communication system to which the present disclosure may be applied.

FIG. 3 illustrates a resource grid in a wireless communication system to which the present disclosure may be applied.

FIG. 4 illustrates a physical resource block in a wireless communication system to which the present disclosure may be applied.

FIG. 5 illustrates a slot structure in a wireless communication system to which the present disclosure may be applied.

FIG. 6 illustrates physical channels used in a wireless communication system to which the present disclosure may be applied and a general signal transmission and reception method using them.

FIG. 7 is a diagram for describing an example of CG PUSCH transmission and retransmission operations according to the present disclosure.

FIG. 8 is a diagram for describing an example of a configured uplink grant-based transmission/retransmission operation of a terminal according to the present disclosure.

FIG. 9 is a diagram for describing an example of an operation in which a base station receives configured uplink grant-based transmission/retransmission from a terminal according to the present disclosure.

FIG. 10 illustrates a block diagram of a wireless communication system according to an embodiment of the present disclosure.

### DETAILED DESCRIPTION

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

The present disclosure describes a wireless communication network or a wireless communication system, and an operation performed in a wireless communication network may be performed in a process in which a device (e.g., a base station) controlling a corresponding wireless communication network controls a network and transmits or receives a signal, or may be performed in a process in which a terminal associated to a corresponding wireless network transmits or receives a signal with a network or between terminals.

In the present disclosure, transmitting or receiving a channel includes a meaning of transmitting or receiving information or a signal through a corresponding channel. For example, transmitting a control channel means that control information or a control signal is transmitted through a control channel. Similarly, transmitting a data channel means that data information or a data signal is transmitted through a data channel.

Hereinafter, a downlink (DL) means a communication from a base station to a terminal and an uplink (UL) means a communication from a terminal to a base station. In a downlink, a transmitter may be part of a base station and a receiver may be part of a terminal. In an uplink, a transmitter may be part of a terminal and a receiver may be part of a base station. A base station may be expressed as a first communication device and a terminal may be expressed as a second communication device. A base station (BS) may be substituted with a term such as a fixed station, a Node B, an eNB (evolved-NodeB), a gNB (Next Generation NodeB), a BTS (base transceiver system), an Access Point (AP), a Network (5G network), an AI (Artificial Intelligence) system/module, an RSU (road side unit), a robot, a drone (UAV: Unmanned Aerial Vehicle), an AR (Augmented Reality) device, a VR (Virtual Reality) device, etc. In addition, a terminal may be fixed or mobile, and may be substituted with a term such as a UE (User Equipment), an MS (Mobile Station), a UT (user terminal), an MSS (Mobile Subscriber Station), an SS (Subscriber Station), an AMS (Advanced Mobile Station), a WT (Wireless terminal), an MTC (Machine-Type Communication) device, an M2M (Machine-to-Machine) device, a D2D (Device-to-Device) device, a vehicle, an RSU (road side unit), a robot, an AI (Artificial Intelligence) module, a drone (UAV: Unmanned Aerial Vehicle), an AR (Augmented Reality) device, a VR (Virtual Reality) device, etc.

The following description may be used for a variety of radio access systems such as CDMA, FDMA, TDMA, OFDMA, SC-FDMA, etc. CDMA may be implemented by a wireless technology such as UTRA (Universal Terrestrial Radio Access) or CDMA2000. TDMA may be implemented by a radio technology such as GSM (Global System for Mobile communications)/GPRS (General Packet Radio Service)/EDGE (Enhanced Data Rates for GSM Evolution). OFDMA may be implemented by a radio technology such as IEEE 802.11 (Wi-Fi), IEEE 802.16 (WiMAX), IEEE 802-20, E-UTRA (Evolved UTRA), etc. UTRA is a part of a UMTS (Universal Mobile Telecommunications System). 3GPP (3rd Generation Partnership Project) LTE (Long Term Evolution) is a part of an E-UMTS (Evolved UMTS) using E-UTRA and LTE-A (Advanced)/LTE-A pro is an advanced version of 3GPP LTE. 3GPP NR (New Radio or New Radio Access Technology) is an advanced version of 3GPP LTE/LTE-A/LTE-A pro.

To clarify description, it is described based on a 3GPP communication system (e.g., LTE-A, NR), but a technical idea of the present disclosure is not limited thereto. LTE means a technology after 3GPP TS (Technical Specification) 36.xxx Release 8. In detail, an LTE technology in or after 3GPP TS 36.xxx Release 10 is referred to as LTE-A and an LTE technology in or after 3GPP TS 36.xxx Release 13 is referred to as LTE-A pro. 3GPP NR means a technology in or after TS 38.xxx Release 15. LTE/NR may be referred to as a 3GPP system. “xxx” means a detailed number for a standard document. LTE/NR may be commonly referred to as a 3GPP system. For a background art, a term, an abbreviation, etc. used to describe the present disclosure, matters described in a standard document disclosed before the present disclosure may be referred to. For example, the following document may be referred to.

For 3GPP LTE, TS 36.211 (physical channels and modulation), TS 36.212 (multiplexing and channel coding), TS 36.213 (physical layer procedures), TS 36.300 (overall description), TS 36.331 (radio resource control) may be referred to.

For 3GPP NR, TS 38.211 (physical channels and modulation), TS 38.212 (multiplexing and channel coding), TS 38.213 (physical layer procedures for control), TS 38.214 (physical layer procedures for data), TS 38.300 (NR and NG-RAN (New Generation-Radio Access Network) overall description), TS 38.331 (radio resource control protocol specification) may be referred to.

Abbreviations of terms which may be used in the present disclosure is defined as follows.
BM: beam management
CQI: Channel Quality Indicator
CRI: channel state information-reference signal resource indicator
CSI: channel state information
CSI-IM: channel state information-interference measurement
CSI-RS: channel state information-reference signal
DMRS: demodulation reference signal
FDM: frequency division multiplexing
FFT: fast Fourier transform
IFDMA: interleaved frequency division multiple access
IFFT: inverse fast Fourier transform
L1-RSRP: Layer 1 reference signal received power
L1-RSRQ: Layer 1 reference signal received quality
MAC: medium access control
NZP: non-zero power
OFDM: orthogonal frequency division multiplexing
PDCCH: physical downlink control channel
PDSCH: physical downlink shared channel
PMI: precoding matrix indicator
RE: resource element
RI: Rank indicator
RRC: radio resource control
RSSI: received signal strength indicator
Rx: Reception
QCL: quasi co-location
SINR: signal to interference and noise ratio
SSB (or SS/PBCH block): Synchronization signal block (including PSS (primary synchronization signal), SSS (secondary synchronization signal) and PBCH (physical broadcast channel))
TDM: time division multiplexing
TRP: transmission and reception point
TRS: tracking reference signal
Tx: transmission
UE: user equipment
ZP: zero power

### Overall System

As more communication devices have required a higher capacity, a need for an improved mobile broadband communication compared to the existing radio access technology (RAT) has emerged. In addition, massive MTC (Machine Type Communications) providing a variety of services anytime and anywhere by connecting a plurality of devices and things is also one of main issues which will be considered in a next-generation communication. Furthermore, a communication system design considering a service/a terminal sensitive to reliability and latency is also discussed. As such, introduction of a next-generation RAT considering eMBB (enhanced mobile broadband communication), mMTC (massive MTC), URLLC (Ultra-Reliable and Low Latency Communication), etc. is discussed and, for convenience, a corresponding technology is referred to as NR in the present disclosure. NR is an expression which represents an example of a 5G RAT.

A new RAT system including NR uses an OFDM transmission method or a transmission method similar to it. A new RAT system may follow OFDM parameters different from OFDM parameters of LTE. Alternatively, a new RAT system follows a numerology of the existing LTE/LTE-A as it is, but may support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

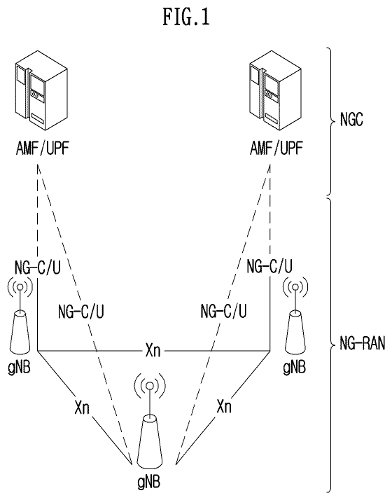

FIG. 1 illustrates a structure of a wireless communication system to which the present disclosure may be applied.

In reference to FIG. 1, NG-RAN is configured with gNBs which provide a control plane (RRC) protocol end for a NG-RA (NG-Radio Access) user plane (i.e., a new AS (access stratum) sublayer/PDCP (Packet Data Convergence Protocol)/RLC (Radio Link Control)/MAC/PHY) and UE. The gNBs are interconnected through a Xn interface. The gNB, in addition, is connected to an NGC (New Generation Core) through an NG interface. In more detail, the gNB is connected to an AMF (Access and Mobility Management Function) through an N2 interface, and is connected to a UPF (User Plane Function) through an N3 interface.

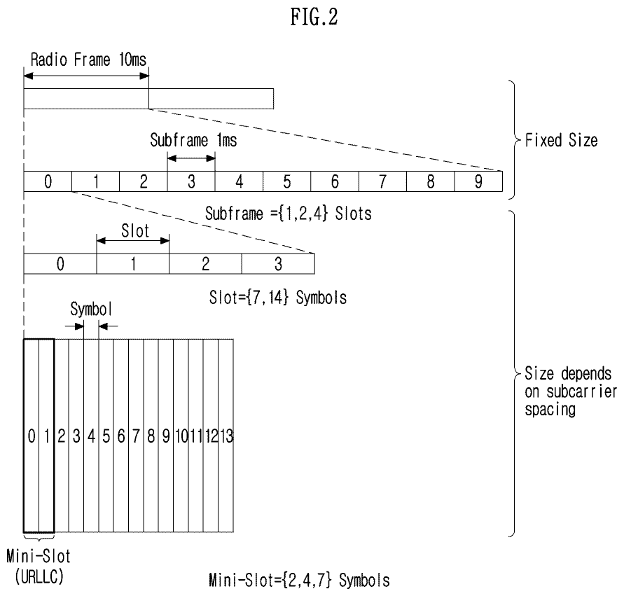

FIG. 2 illustrates a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a basic (reference) subcarrier spacing by an integer N (or, u). In addition, although it is assumed that a very low subcarrier spacing is not used in a very high carrier frequency, a used numerology may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| μ | Δf = 2^{μ} · 15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, dense-urban, lower latency and a wider carrier bandwidth are supported, and when a SCS is 60 kHz or higher, a bandwidth wider than 24.25 GHz is supported to overcome a phase noise. An NR frequency band is defined as a frequency range in two types (FR1, FR2). FR1, FR2 may be configured as in the following Table 2. In addition, FR2 may mean a millimeter wave (mmW).

TABLE 2

| Frequency Range | Corresponding | | |
|---|---|---|---|
| designation | frequency range | Subcarrier Spacing | |
| FR1 | 410 MHz-7125 MHz | 15, 30, 60 | kHz |
| FR2 | 24250 MHz-52600 MHz | 60, 120, 240 | kHz |

Regarding a frame structure in an NR system, a size of a variety of fields in a time domain is expresses as a multiple of a time unit of T_{c}=1/(Δfₘₐₓ·N_{f}). Here, Δfₘₐₓ is 480.103 Hz and N_{f} is 4096. Downlink and uplink transmission is configured (organized) with a radio frame having a duration of T_{f}=1/(ΔfₘₐₓN_{f}/100)·T_{c}=10 ms. Here, a radio frame is configured with 10 subframes having a duration of T_{sf}=(ΔfₘₐₓN_{f}/1000)·T_{c}=1 ms, respectively. In this case, there may be one set of frames for an uplink and one set of frames for a downlink. In addition, transmission in an uplink frame No. i from a terminal should start earlier by T_{TA}=(N_{TA}+N_{TA,offset})T_{c} than a corresponding downlink frame in a corresponding terminal starts. For a subcarrier spacing configuration u, slots are numbered in an increasing order of nₛ^{μ}∈{0, . . . , Nₛₗₒₜ^{subframe,μ}−1} in a subframe and are numbered in an increasing order of n_{s,f}^{μ}∈{0, . . . , Nₛₗₒₜ^{frame,μ}−1} in a radio frame. One slot is configured with N_{symb}^{slot} consecutive OFDM symbols and N_{symb}^{slot} is determined according to CP. A start of a slot nₛ^{μ} in a subframe is temporally arranged with a start of an OFDM symbol nₛ^{μ}N_{symb}^{slot} in the same subframe. All terminals may not perform transmission and reception at the same time, which means that all OFDM symbols of a downlink slot or an uplink slot may not be used. Table 3 represents the number of OFDM symbols per slot (N_{symb}^{slot}), the number of slots per radio frame (Nₛₗₒₜ^{frame,μ}) and the number of slots per subframe (Nₛₗₒₜ^{subframe,μ}) in a normal CP and Table 4 represents the number of OFDM symbols per slot, the number of slots per radio frame and the number of slots per subframe in an extended CP.

TABLE 3

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame, μ} | Nₛₗₒₜ^{subframe, μ} |
|---|---|---|---|
| 2 | 12 | 40 | 4 |

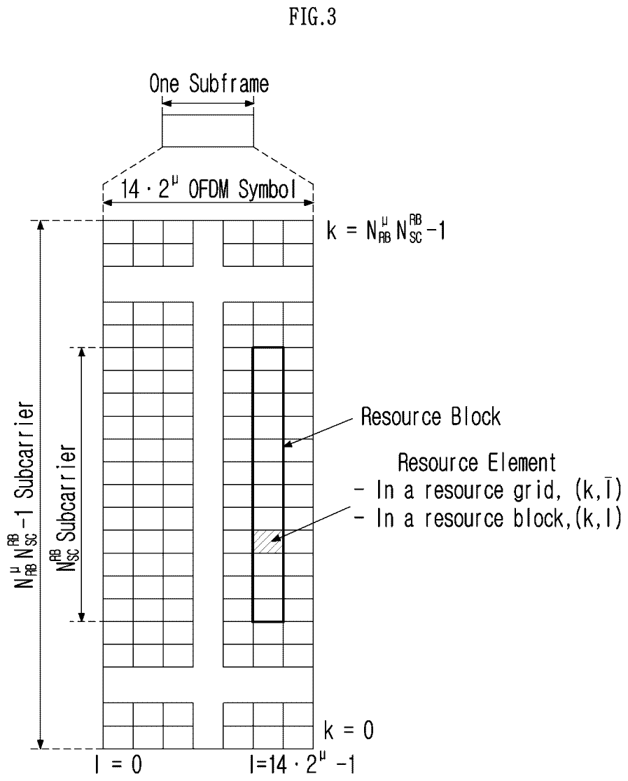

FIG. 2 is an example on μ=2 (SCS is 60 kHz), 1 subframe may include 4 slots referring to Table 3. 1 subframe={1, 2, 4} slot shown in FIG. 2 is an example, the number of slots which may be included in 1 subframe is defined as in Table 3 or Table 4. In addition, a mini-slot may include 2, 4 or 7 symbols or more or less symbols. Regarding a physical resource in a NR system, an antenna port, a resource grid, a resource element, a resource block, a carrier part, etc. may be considered. Hereinafter, the physical resources which may be considered in an NR system will be described in detail. First, in relation to an antenna port, an antenna port is defined so that a channel where a symbol in an antenna port is carried can be inferred from a channel where other symbol in the same antenna port is carried. When a large-scale property of a channel where a symbol in one antenna port is carried may be inferred from a channel where a symbol in other antenna port is carried, it may be said that 2 antenna ports are in a QC/QCL (quasi co-located or quasi co-location) relationship. In this case, the large-scale property includes at least one of delay spread, doppler spread, frequency shift, average received power, received timing. FIG. 3 illustrates a resource grid in a wireless communication system to which the present disclosure may be applied. In reference to FIG. 3, it is illustratively described that a resource grid is configured with N_{RB}^{μ}N_{sc}^{RB} subcarriers in a frequency domain and one subframe is configured with 14·2^{μ} OFDM symbols, but it is not limited thereto. In an NR system, a transmitted signal is described by OFDM symbols of 2^{μ}N_{symb}^{(μ)} and one or more resource grids configured with N_{RB}^{μ}N_{sc}^{RB} subcarriers. Here, N_{RB}^{μ}≤N_{RB}^{max,μ}. The N_{RB}^{max,μ} represents a maximum transmission bandwidth, which may be different between an uplink and a downlink as well as between numerologies. In this case, one resource grid may be configured per μ and antenna port p. Each element of a resource grid for μ and an antenna port p is referred to as a resource element and is uniquely identified by an index pair (k,l′). Here, k=0, . . . , N_{RB}^{μ}N_{sc}^{RB}−1 is an index in a frequency domain and l′=0, . . . , 2^{μ}N_{symb}^{(μ)}−1 refers to a position of a symbol in a subframe. When referring to a resource element in a slot, an index pair (k,l) is used. Here, l=0, . . . , N_{symb}^{μ}−1. A resource element (k,l′) for u and an antenna port p corresponds to a complex value, a_{k,l′}^{(p,μ)}. When there is no risk of confusion or when a specific antenna port or numerology is not specified, indexes p and μ may be dropped, whereupon a complex value may be a_{k,l′}^{(p)} or a_{k,l′}. In addition, a resource block (RB) is defined as N_{sc}^{RB}=12 consecutive subcarriers in a frequency domain.

Point A plays a role as a common reference point of a resource block grid and is obtained as follows.

offsetToPointA for a primary cell (PCell) downlink represents a frequency offset between point A and the lowest subcarrier of the lowest resource block overlapped with a SS/PBCH block which is used by a terminal for an initial cell selection. It is expressed in resource block units assuming a 15 kHz subcarrier spacing for FR1 and a 60 kHz subcarrier spacing for FR2.

absoluteFrequencyPointA represents a frequency-position of point A expressed as in ARFCN (absolute radio-frequency channel number).

Common resource blocks are numbered from 0 to the top in a frequency domain for a subcarrier spacing configuration μ. The center of subcarrier 0 of common resource block 0 for a subcarrier spacing configuration μ is identical to ‘point A’. A relationship between a common resource block number n_{CRB}^{μ} and a resource element (k,l) for a subcarrier spacing configuration μ in a frequency domain is given as in the following Equation 1.

$${n}_{CRB}^{μ} = ⌊ \frac{k}{{N}_{sc}^{RB}} ⌋ \qquad [ Equation 1 ]$$

In Equation 1, k is defined relatively to point A so that k=0 corresponds to a subcarrier centering in point A. Physical resource blocks are numbered from 0 to N_{BWP,i}^{size,μ}−1 in a bandwidth part (BWP) and i is a number of a BWP. A relationship between a physical resource block n_{PRB} and a common resource block nCRB in BWP i is given by the following Equation 2.

$${n}_{CRB}^{μ} = {n}_{PRB}^{μ} + {N}_{BWP , i}^{start , μ} \qquad [ Equation 2 ]$$

N_{BWP,i}^{start,μ} is a common resource block that a BWP starts relatively to common resource block 0.

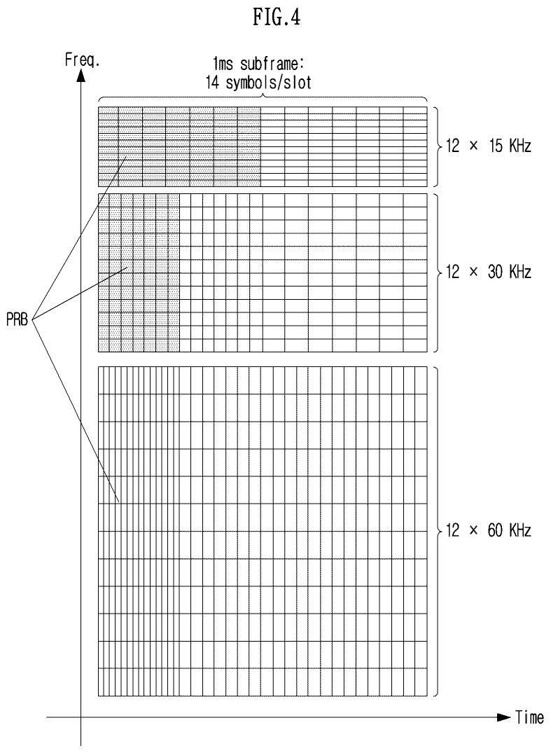

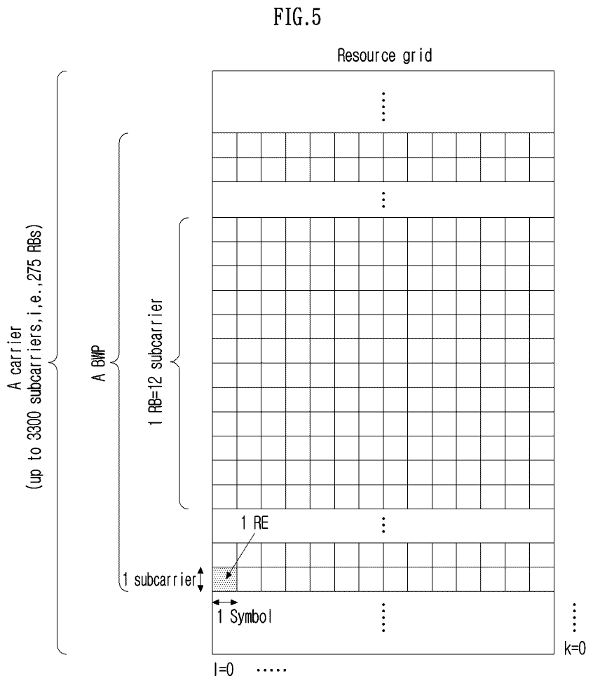

FIG. 4 illustrates a physical resource block in a wireless communication system to which the present disclosure may be applied. And, FIG. 5 illustrates a slot structure in a wireless communication system to which the present disclosure may be applied.

In reference to FIG. 4 and FIG. 5, a slot includes a plurality of symbols in a time domain. For example, for a normal CP, one slot includes 7 symbols, but for an extended CP, one slot includes 6 symbols.

A carrier includes a plurality of subcarriers in a frequency domain. An RB (Resource Block) is defined as a plurality of (e.g., 12) consecutive subcarriers in a frequency domain. A BWP (Bandwidth Part) is defined as a plurality of consecutive (physical) resource blocks in a frequency domain and may correspond to one numerology (e.g., an SCS, a CP length, etc.). A carrier may include a maximum N (e.g., 5) BWPs. A data communication may be performed through an activated BWP and only one BWP may be activated for one terminal. In a resource grid, each element is referred to as a resource element (RE) and one complex symbol may be mapped.

In an NR system, up to 400 MHz may be supported per component carrier (CC). If a terminal operating in such a wideband CC always operates turning on a radio frequency (FR) chip for the whole CC, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. By considering it, a base station may indicate a terminal to operate only in a partial bandwidth, not in a full bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured to a terminal. For example, a BWP occupying a relatively small frequency domain may be configured in a PDCCH monitoring slot, and a PDSCH indicated by a PDCCH may be scheduled in a greater BWP. Alternatively, when UEs are congested in a specific BWP, some terminals may be configured with other BWP for load balancing. Alternatively, considering frequency domain inter-cell interference cancellation between neighboring cells, etc., some middle spectrums of a full bandwidth may be excluded and BWPs on both edges may be configured in the same slot. In other words, a base station may configure at least one DL/UL BWP to a terminal associated with a wideband CC. A base station may activate at least one DL/UL BWP of configured DL/UL BWP(s) at a specific time (by L1 signaling or MAC CE (Control Element) or RRC signaling, etc.). In addition, a base station may indicate switching to other configured DL/UL BWP (by L1 signaling or MAC CE or RRC signaling, etc.).

Alternatively, based on a timer, when a timer value is expired, it may be switched to a determined DL/UL BWP. Here, an activated DL/UL BWP is defined as an active DL/UL BWP. But, a configuration on a DL/UL BWP may not be received when a terminal performs an initial access procedure or before a RRC connection is set up, so a DL/UL BWP which is assumed by a terminal under these situations is defined as an initial active DL/UL BWP.

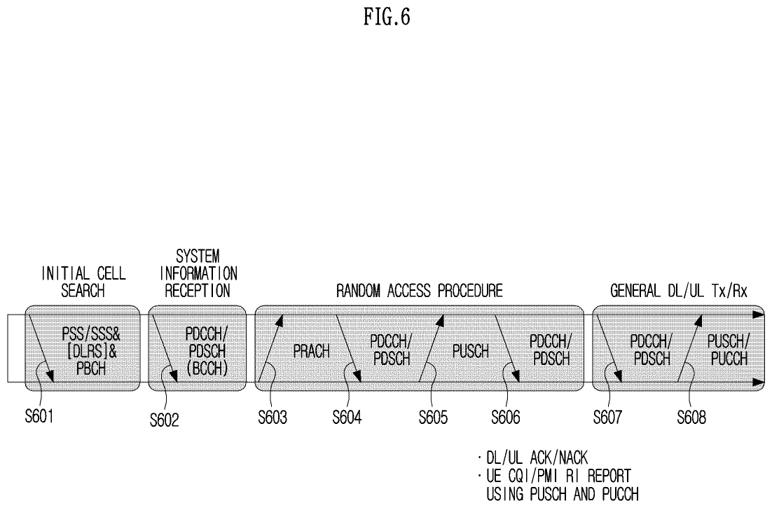

FIG. 6 illustrates physical channels used in a wireless communication system to which the present disclosure may be applied and a general signal transmission and reception method using them.

In a wireless communication system, a terminal receives information through a downlink from a base station and transmits information through an uplink to a base station. Information transmitted and received by a base station and a terminal includes data and a variety of control information and a variety of physical channels exist according to a type/a usage of information transmitted and received by them.

When a terminal is turned on or newly enters a cell, it performs an initial cell search including synchronization with a base station or the like (S601). For the initial cell search, a terminal may synchronize with a base station by receiving a primary synchronization signal (PSS) and a secondary synchronization signal (SSS) from a base station and obtain information such as a cell identifier (ID), etc. After that, a terminal may obtain broadcasting information in a cell by receiving a physical broadcast channel (PBCH) from a base station. Meanwhile, a terminal may check out a downlink channel state by receiving a downlink reference signal (DL RS) at an initial cell search stage.

A terminal which completed an initial cell search may obtain more detailed system information by receiving a physical downlink control channel (PDCCH) and a physical downlink shared channel (PDSCH) according to information carried in the PDCCH (S602).

Meanwhile, when a terminal accesses to a base station for the first time or does not have a radio resource for signal transmission, it may perform a random access (RACH) procedure to a base station (S603 to S606). For the random access procedure, a terminal may transmit a specific sequence as a preamble through a physical random access channel (PRACH) (S603 and S605) and may receive a response message for a preamble through a PDCCH and a corresponding PDSCH (S604 and S606). A contention based RACH may additionally perform a contention resolution procedure.

A terminal which performed the above-described procedure subsequently may perform PDCCH/PDSCH reception (S607) and PUSCH (Physical Uplink Shared Channel)/PUCCH (physical uplink control channel) transmission (S608) as a general uplink/downlink signal transmission procedure. In particular, a terminal receives downlink control information (DCI) through a PDCCH. Here, DCI includes control information such as resource allocation information for a terminal and a format varies depending on its purpose of use.

Meanwhile, control information which is transmitted by a terminal to a base station through an uplink or is received by a terminal from a base station includes a downlink/uplink ACK/NACK (Acknowledgement/Non-Acknowledgement) signal, a CQI (Channel Quality Indicator), a PMI (Precoding Matrix Indicator), a RI (Rank Indicator), etc. For a 3GPP LTE system, a terminal may transmit control information of the above-described CQI/PMI/RI, etc. through a PUSCH and/or a PUCCH.

Table 5 represents an example of a DCI format in an NR system.

TABLE 5

| DCI Format | Use |
|---|---|
| 0_0 | Scheduling of a PUSCH in one cell |
| 0_1 | Scheduling of one or multiple PUSCHs in one |
| | cell, or indication of cell group downlink |
| | feedback information to a UE |
| 0_2 | Scheduling of a PUSCH in one cell |
| 1_0 | Scheduling of a PDSCH in one DL cell |
| 1_1 | Scheduling of a PDSCH in one cell |
| 1_2 | Scheduling of a PDSCH in one cell |

In reference to Table 5, DCI formats 0_0, 0_1 and 0_2 may include resource information (e.g., UL/SUL (Supplementary UL), frequency resource allocation, time resource allocation, frequency hopping, etc.), information related to a transport block (TB) (e.g., MCS (Modulation Coding and Scheme), a NDI (New Data Indicator), a RV (Redundancy Version), etc.), information related to a HARQ (Hybrid-Automatic Repeat and request) (e.g., a process number, a DAI (Downlink Assignment Index), PDSCH-HARQ feedback timing, etc.), information related to multiple antennas (e.g., DMRS sequence initialization information, an antenna port, a CSI request, etc.), power control information (e.g., PUSCH power control, etc.) related to scheduling of a PUSCH and control information included in each DCI format may be pre-defined. DCI format 0_0 is used for scheduling of a PUSCH in one cell. Information included in DCI format 0_0 is CRC (cyclic redundancy check) scrambled by a C-RNTI (Cell Radio Network Temporary Identifier) or a CS-RNTI (Configured Scheduling RNTI) or a MCS-C-RNTI (Modulation Coding Scheme Cell RNTI) and transmitted. DCI format 0_1 is used to indicate scheduling of one or more PUSCHs or configure grant (CG) downlink feedback information to a terminal in one cell. Information included in DCI format 0_1 is CRC scrambled by a C-RNTI or a CS-RNTI or a SP-CSI-RNTI (Semi-Persistent CSI RNTI) or a MCS-C-RNTI and transmitted. DCI format 0_2 is used for scheduling of a PUSCH in one cell. Information included in DCI format 0_2 is CRC scrambled by a C-RNTI or a CS-RNTI or a SP-CSI-RNTI or a MCS-C-RNTI and transmitted.

Next, DCI formats 1_0, 1_1 and 1_2 may include resource information (e.g., frequency resource allocation, time resource allocation, VRB (virtual resource block)-PRB (physical resource block) mapping, etc.), information related to a transport block (TB) (e.g., MCS, NDI, RV, etc.), information related to a HARQ (e.g., a process number, DAI, PDSCH-HARQ feedback timing, etc.), information related to multiple antennas (e.g., an antenna port, a TCI (transmission configuration indicator), a SRS (sounding reference signal) request, etc.), information related to a PUCCH (e.g., PUCCH power control, a PUCCH resource indicator, etc.) related to scheduling of a PDSCH and control information included in each DCI format may be pre-defined.

DCI format 1_0 is used for scheduling of a PDSCH in one DL cell. Information included in DCI format 1_0 is CRC scrambled by a C-RNTI or a CS-RNTI or a MCS-C-RNTI and transmitted.

DCI format 1_1 is used for scheduling of a PDSCH in one cell. Information included in DCI format 1_1 is CRC scrambled by a C-RNTI or a CS-RNTI or a MCS-C-RNTI and transmitted.

DCI format 1_2 is used for scheduling of a PDSCH in one cell. Information included in DCI format 1_2 is CRC scrambled by a C-RNTI or a CS-RNTI or a MCS-C-RNTI and transmitted.

### Configured Uplink Grant-Based Transmission and Retransmission Considering Network Energy Saving (NES)

A terminal may support reception based on beamforming in receiving a downlink. In other words, a terminal may receive a downlink signal by using a specific beam among a plurality of candidate beams. When a terminal is in a connected mode, a base station and a terminal may maintain an optimal beam for a terminal through a beam management (BM) process. Accordingly, a base station may use an optimal transmission (TX) beam suitable for a terminal to transmit a downlink physical channel (e.g., a PDCCH, a PDSCH, etc.), and a terminal may use an optimal reception (RX) beam to receive a downlink physical channel.

In order to refine a wireless communication system, a method for reducing the power consumption of a network node (e.g., a base station, a cell, a TRP, a relays, etc.) is being discussed. For example, a network node that may use a plurality of TX beams and/or RX beams may perform communication with a terminal through some beams (e.g., CSI-RS resources, SSB resources, etc.) (s) in a specific time period and may not perform communication with a terminal through the remaining beam(s) in order to reduce its power consumption. In addition, a network node may perform communication with a terminal through some other beam(s) in a different time period and may not perform communication with a terminal through the remaining beam(s). In other words, a network node may deactivate (or turn OFF) some beam resource(s) that are the same/different for each time period for NES.

In the present disclosure, when a network node operates in a NES mode, it may mean that the following operation is performed. For example, a network node may configure a plurality of periods (i.e., the discontinuous transmission (DTX) periods of a network node) that activate/turn on (or deactivate/turn off) the transmission of specific DL signal(s) during a specific time period in advance. For example, a network node may dynamically indicate to a terminal one ON (or OFF) period among a plurality of configured ON (or OFF) periods, and a terminal may know that a DL signal associated with a corresponding OFF period will not be transmitted from a network node within an indicated OFF period. Along with or separately from this, a network node may configure a plurality of periods (i.e., the discontinuous reception (DRX) periods of a network node) that activate/turn on (or deactivate/turn off) the reception of specific UL signal(s) during a specific time period in advance. A network node may dynamically indicate to a terminal one ON (or OFF) period among a plurality of configured ON (or OFF) periods, and a terminal may know that an UL signal associated with a corresponding OFF period will not be received in a network node within an indicated OFF period. Accordingly, the power consumption of a network node and a terminal may be saved.

In a NES mode, an ON/OFF period may be defined in a time, frequency and/or spatial domain. For example, an ON/OFF period may be defined in a time domain, and the time length of a plurality of ON/OFF periods may be the same or different. For example, an ON/OFF period may be defined in a frequency domain through a method such as BWP switching, dynamic RB adaptation, etc. For example, an ON/OFF period may be defined in a spatial domain by semi-statically or dynamically activating/deactivating the specific antenna port of a network node (i.e., a network node does not transmit/receive a wireless signal through a corresponding antenna port).

Regarding the application of a configured uplink grant-based transmission/retransmission operation according to the present disclosure, a network node may activate or deactivate a NES mode. For example, when one base station controls a plurality of cells, whether to activate a NES mode may be applied independently for each cell. In addition, a network node may inform a terminal of information about NES activation or deactivation.

Unless otherwise limited in the present disclosure, a configuration for a terminal by a base station may include providing corresponding configuration information to a terminal through higher layer (e.g., RRC) signaling. Unless otherwise limited in the present disclosure, a command/an indication for a terminal by a base station may include providing a corresponding command/indication to a terminal through MAC CE and/or DCI. Unless otherwise limited in the present disclosure, information predefined for a base station and a terminal may include information that is held in advance by a base station and a terminal without separate signaling/command/indication for corresponding information.

A configured uplink grant may correspond to information for pre-allocating a periodic uplink resource. For example, information on a configured uplink grant and its periodicity may be provided to a terminal by a higher layer (e.g., RRC), or information on the periodicity of an uplink grant may be provided by a higher layer, and then an uplink grant may be activated or deactivated by PDCCH/DCI signaling. In the present disclosure, data transmission through a PUSCH based on a configured uplink grant is referred to as configured grant (CG) PUSCH transmission. Scheduling information for the initial transmission or new transmission of a CG PUSCH may be configured by a higher layer as described above. Retransmission of a CG PUSCH may be performed when a receiving end (i.e., a network node) fails to decode a CG PUSCH. For CG PUSCH retransmission, a method for dynamically scheduling a retransmission resource through a PDCCH (e.g., if HARQ process identification information included in a PDCCH/DCI relates to a CG, a TB transmitted by a CG method is retransmitted by using an uplink grant provided through DCI), or a method for using some CGs for initial/new transmission and using the remaining CGs for retransmission (e.g., an initial/new transmission CG is distinct from a retransmission CG based on a cg-retransmission timer) may be applied.

A new method is needed that accurately aligns the CG PUSCH transmission and/or retransmission of a terminal according to the NES operation of a network node. Specifically, an operation may be defined in which a terminal connected to a network node performing a NES operation performs or does not perform CG PUSCH transmission/retransmission by considering the NES-related period of a network node. In other words, the present disclosure describes various examples in which CG PUSCH transmission/retransmission is performed by considering the DRX period and/or DTX period (i.e., the cell DTX period and/or the cell DRX period) of a network node supporting NES.

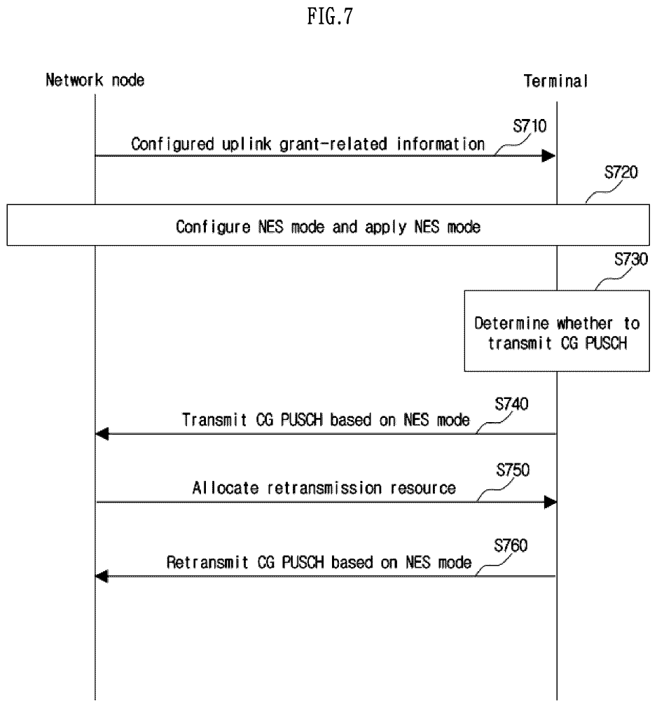

FIG. 7 is a diagram for describing an example of CG PUSCH transmission and retransmission operations according to the present disclosure.

In S710, configuration information on a configured uplink grant may be provided for a terminal. A configured uplink grant may include information on a periodic uplink scheduling resource.

In S720, a network node may provide/configure NES mode-related information to a terminal and indicate NES mode application/activation. S710 and S720 may be performed in parallel or sequentially.

NES mode-related information may include information, for example, on configuring only cell DTX, configuring only cell DRX or configuring both cell DTX and cell DRX. Applying/activating a NES mode may include that a terminal determines a period during which cell DTX/DRX is applied based on information on a cell DTX/DRX active period and performs a transmission/reception operation based thereon.

For example, a cell DTX/DRX active period may be determined based on information on a length (i.e., on-duration) for which a cell DTX/DRX cycle starts and is maintained, an offset for a time period (e.g., a sub-frame and/or a slot) during which a cell DTX/DRX cycle starts and the periodicity of a cell DTX/DRX cycle. A cell DTX active period may correspond to a period during which a network node performs downlink transmission. In other words, while a cell is not in a cell DTX active period, a network node may not perform downlink transmission. A cell DRX active period may correspond to a period during which a network node performs uplink reception. In other words, while a cell is not in a cell DRX active period, a network node may not perform uplink reception. For example, when cell DTX/DRX is configured, a cell DTX/DRX active period may include the time during which a cell DTX/DRX on-duration timer is running.

In S730, a terminal may determine whether to perform CG PUSCH transmission. For example, a terminal may determine whether to perform CG PUSCH transmission based on the cell DTX and/or cell DRX active period of a network node according to at least one of the various examples of the present disclosure described below. When CG PUSCH transmission is determined, a terminal may perform NES mode-based CG PUSCH transmission in S740.

When a network node fails to decode a TB transmitted from a terminal through a CG PUSCH, a network node may indicate retransmission for a corresponding TB to a corresponding terminal, i.e., allocate a retransmission resource, in S750.

In S760, a terminal may perform NES mode-based CG PUSCH retransmission to a network node based on an allocated retransmission resource.

Hereinafter, examples of the present disclosure for retransmission and a new method for transmitting a configured uplink grant-based uplink based on a NES mode, and in particular, based on a cell DTX active period and/or a cell DRX active period are described.

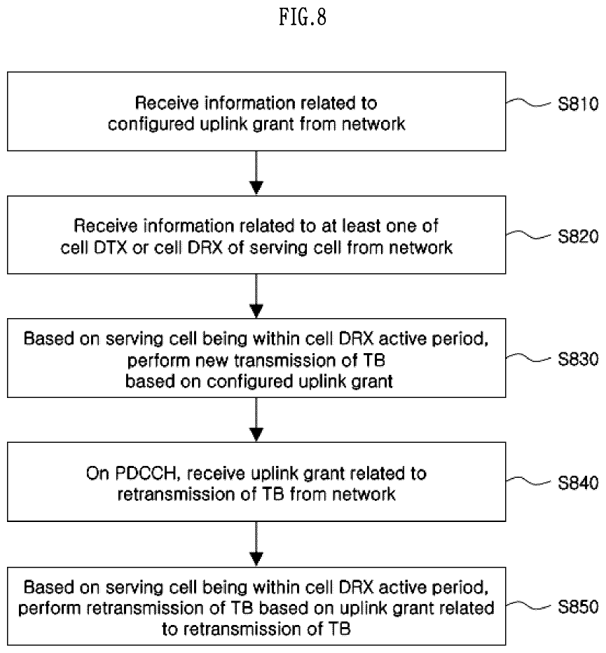

FIG. 8 is a diagram for describing an example of a configured uplink grant-based transmission/retransmission operation of a terminal according to the present disclosure.

In S810, a terminal may receive information related to a configured uplink grant from a network. Information related to a configured uplink grant may include information on resource allocation, periodicity, etc.

In S820, a terminal may receive information related to at least one of the cell discontinuous transmission (DTX) or cell discontinuous reception (DRX) of a serving cell from a network.

Based on information related to at least one of the cell DTX or cell DRX of a serving cell, only cell DTX, only cell DRX or both cell DTX and cell DRX may be configured for a terminal.

Information related to at least one of the cell DTX or cell DRX of a serving cell may further include timer information related to the cell DTX active time and/or the cell DRX active time. For example, the cell DTX active time may include the time during which an on-duration timer related to cell DTX is running. The cell DRX active time may include the time during which an on-duration timer related to cell DRX is running.

In S830, a terminal may perform the new transmission of a TB based on a configured uplink grant based on a serving cell being within a cell DRX active period. The new transmission of a TB may include that a configured uplink grant and related HARQ information is delivered to a HARQ entity in the MAC layer of a terminal, that a HARQ entity obtains a TB (or a MAC PDU) from another entity (e.g., a multiplexing and assembly entity) for a corresponding configured uplink grant and that a HARQ entity instructs a HARQ process related to a corresponding configured uplink grant to trigger the new transmission of a corresponding TB and a HARQ process instructs the physical (PHY) layer of a terminal to generate new transmission.

Based on a serving cell not being in a cell DRX active period, a TB may not be generated in the MAC layer of a terminal. For example, when a TB is not generated in a MAC layer, it may include that a corresponding TB is not obtained by the entity of a MAC layer (e.g., a HARQ entity) for a configured uplink grant. Accordingly, a subsequent process (e.g., an operation for instructing a HARQ entity to trigger new transmission to a HARQ process or a HARQ process to generate new transmission to a PHY layer) may not be performed.

In S840, a terminal may receive an uplink grant related to the retransmission of a TB from a network on a PDCCH.

An uplink grant related to the retransmission of a TB may include information on an uplink resource for the retransmission of a TB based on a configured uplink grant. In other words, the retransmission of a TB may be transmitted through a resource allocated by the uplink grant of a PDCCH/DCI (i.e., a dynamic uplink grant), not a resource allocated by a configured uplink grant.

When a serving cell is within a cell DTX active period, a terminal may perform monitoring on a PDCCH. When a serving cell is not within a cell DTX active period, a terminal may not perform monitoring on a PDCCH.

In S850, a terminal may perform the retransmission of a corresponding TB based on an uplink grant related to the retransmission of a TB based on a serving cell being within a cell DRX active period.

A TB transmitted before based on a configured uplink grant may be stored in the MAC layer of a terminal (e.g., a specific HAR Q process buffer within a HARQ entity). In other words, the previous transmission (or new transmissions) of a TB and the retransmission of a corresponding TB may be associated with the same HARQ process.

Based on a serving cell not being in a cell DRX active period, the retransmission of a TB may not be performed in the PHY layer of a terminal. For example, when the retransmission of a TB is not performed in a PHY layer, it may include that (the HARQ entity of a MAC layer) does not instruct a HARQ process to retransmit a TB, and accordingly, a HARQ process does not instruct a PHY layer to generate the retransmission of a TB. Specifically, for the retransmission of a TB (based on a dynamic uplink grant), a corresponding TB may be already generated/obtained in the buffer of a HARQ process associated with the previous (or new) transmission of a corresponding TB (based on a configured uplink grant). Accordingly, in order to prevent the retransmission of a corresponding TB during a cell DTX active period, since a method may not be applied in which a TB is not generated/obtained in a MAC layer (in a similar way to the case of new transmission), it may be defined that the retransmission of a TB is not performed in PHY.

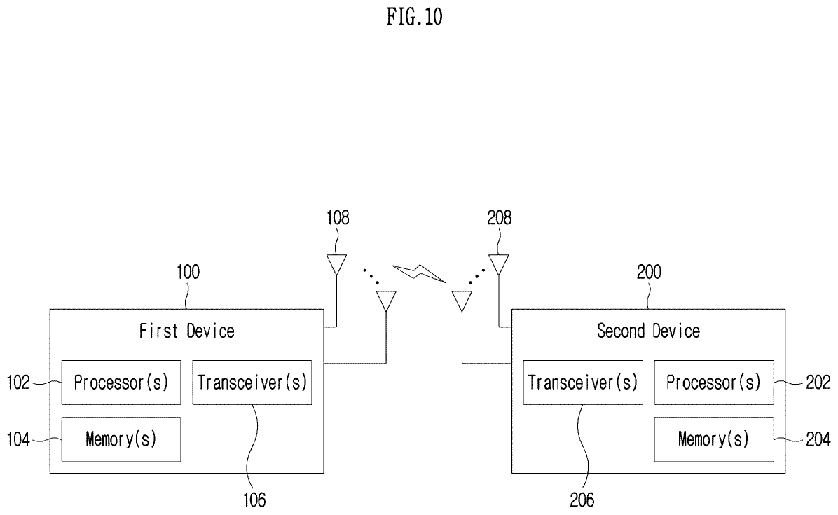

A method described in the example of FIG. 8 may be performed by the first device 100 in FIG. 10. For example, at least one processor 102 of the first device 100 in FIG. 10 may be configured to receive information related to a configured uplink grant from a network through at least one transceiver 106; receive information related to at least one of the cell discontinuous transmission (DTX) or the cell discontinuous reception (DRX) of a serving cell from a network through at least one transceiver 106; based on a serving cell being within a cell DRX active period, perform the new transmission of a transport block (TB) based on a configured uplink grant through at least one transceiver 106; on a PDCCH, receive an uplink grant related to the retransmission of a TB from a network through at least one transceiver 106; and based on a serving cell being within a cell DRX active period, perform the retransmission of a TB based on an uplink grant related to the retransmission of a TB through at least one transceiver 106. Here, based on a serving cell not being in a cell DRX active period, a TB may not be generated in the MAC layer of a terminal. Based on a serving cell not being in a cell DRX active period, the retransmission of a TB may not be performed in the PHY layer of a terminal. Furthermore, at least one memory 104 of a first device 100 may store instructions for performing a method described in the example of FIG. 8 or examples described below when executed by at least one processor 102.

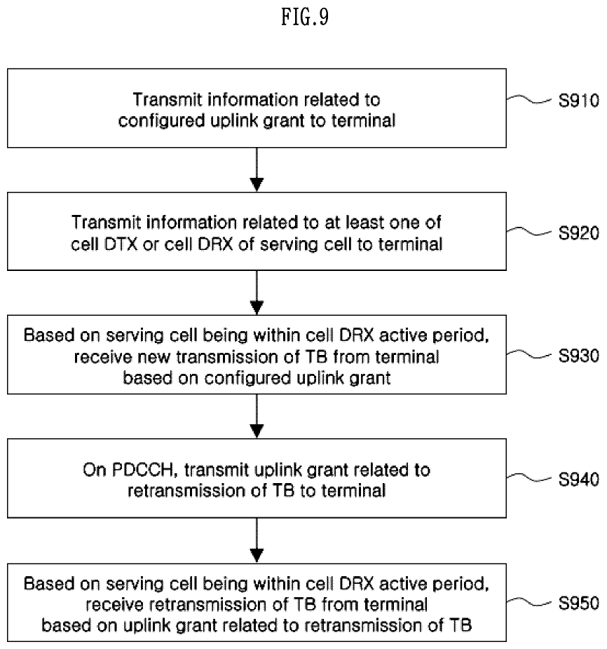

FIG. 9 is a diagram for describing an example of an operation in which a base station receives configured uplink grant-based transmission/retransmission from a terminal according to the present disclosure.

In S910, a base station may transmit information related to a configured uplink grant to a terminal. In S920, a base station may transmit information related to at least one of the cell DTX or the cell DRX of a serving cell to a terminal.

In S930, a base station may receive the new transmission of a TB based on a configured uplink grant from a terminal based on a serving cell being within a cell DRX active period. If a serving cell is not in a cell DRX active period, a base station may not perform a reception operation, and the MAC layer of a terminal may not generate a TB for configured uplink grant-based new transmission.

In S940, a base station may transmit an uplink grant related to the retransmission of a TB to a terminal on a PDCCH. It may be performed when a base station received the previous (or new) transmission of a TB but failed to successfully decode it.

In S950, a base station may receive the retransmission of a TB from a terminal based on an uplink grant related to the retransmission of a TB based on a serving cell being within a cell DRX active period. If a serving cell is not in a cell DRX active period, a base station may not perform a reception operation, and the PHY layer of a terminal may not perform uplink grant-based TB retransmission provided through a PDCCH.

The specific features of a cell DTX active period, a cell DRX active period, configured uplink grant-based new transmission of a TB, an uplink grant related to TB retransmission through a PDCCH and the retransmission of a TB based thereon are the same as described by referring to FIG. 8, so an overlapping description is omitted.

A method described in the example of FIG. 9 may be performed by the second device 200 in FIG. 10. For example, at least one processor 202 of the second device 200 in FIG. 10 may be configured to transmit information related to a configured uplink grant to a terminal through at least one transceiver 206; transmit information related to at least one of the cell DTX or the cell DRX of a serving cell to a terminal through at least one transceiver 206; based on a serving cell being within a cell DRX active period, receive the new transmission of a TB from a terminal based on a configured uplink grant through at least one transceiver 206; on a PDCCH, transmit an uplink grant related to the retransmission of a TB to a terminal through at least one transceiver 206; and based on a serving cell being within a cell DRX active period, receive the retransmission of a TB from a terminal based on an uplink grant related to the retransmission of a TB through at least one transceiver 206. Here, based on a serving cell not being in a cell DRX active period, a TB may not be generated in the MAC layer of a terminal. In addition, based on a serving cell not being in a cell DRX active period, the retransmission of a TB may not be performed in the PHY layer of a terminal.

Furthermore, at least one memory 204 of a second device 200 may store instructions for performing a method described in the example of FIG. 9 or examples described below when executed by at least one processor 202.

Hereinafter, various examples of NES and configured uplink grant-based uplink transmission/retransmission according to the present disclosure are described.

### Embodiment 1

This embodiment relates to a period according to whether a NES mode is applied and a terminal operation in a corresponding period.

Based on one or a plurality of combinations of the examples described below, the first period (e.g., a transmission/reception inactive period) and the second period (e.g., a transmission/reception active period) may be configured for a terminal and accordingly, the operation of a terminal may be determined.

As an example, the first period operating in a NES mode (i.e., transmission/reception OFF) and the second period operating in a non-NES mode (i.e., transmission/reception ON) may be configured/defined.

Additionally or alternatively, the first period during which cell DTX is inactive (i.e., a base station does not perform transmission to a specific cell) and the second period during which cell DTX is active (i.e., a base station may perform transmission to a specific cell) may be configured/defined.

Additionally or alternatively, the first period during which terminal DRX is inactive (i.e., a terminal does not perform reception) and the second period during which terminal DRX is active (i.e., a terminal may perform reception) may be configured/defined.

Additionally or alternatively, the first period during which cell DRX is inactive (i.e., a base station does not perform reception to a specific cell) and the second period during which cell DRX is active (i.e., a base station may perform reception in a specific cell) may be configured/defined.

Additionally or alternatively, the first period during which terminal DTX is inactive (i.e., a terminal does not perform transmission) and the second period during which terminal DTX is active (i.e., a terminal may perform transmission) may be configured/defined.

Each of the first and second periods in the above-described examples may be defined on a time domain or may be defined on at least one of a time, frequency or spatial domain. For example, according to the configuration of a base station, only the second period may be configured/defined or both the first period and the second period may be configured/defined for each combination of a plurality of units or one unit of a cell, a BWP, a frequency, a radio link failure (RLF)-related reference signal (RS), an antenna port (AP), an AP group or an antenna element group.

In addition, a base station may separately configure the first period and/or the second period for each of the above-described examples. In this case, a case in which a specific period is the first period or the second period may occur for different examples. Considering this, when a specific period belongs only to the first period, a terminal may perform an operation in the first period in some examples according to the present disclosure, and when it belongs only to the second period, a terminal may perform an operation in the second period in some examples according to the present disclosure. When the first period and the second period overlap, only an operation in the first period in some examples of the present disclosure may be performed, or an operation in the first period may be performed preferentially. Alternatively, when the first period and the second period overlap, only an operation in the second period in some examples of the present disclosure may be performed, or an operation in the second period may be performed preferentially.

When a configured uplink grant (or a CG) is configured and activated, a terminal may transmit only a PUSCH in which an uplink (UL) slot/symbol corresponding to the second period is included, or may transmit only a PUSCH in which an UL slot/symbol corresponding to the first period is not included, or may transmit only a PUSCH in which all UL slots/symbols configuring a PUSCH are included within the second period.

Here, a PUSCH may be a periodically allocated CG PUSCH or a PUSCH that retransmits the TB of a CG PUSCH. A PUSCH for TB retransmission may be a PUSCH scheduled by a dynamic uplink grant or may be a specific CG PUSCH. For example, a CG PUSCH may be a CG PUSCH which is pre-allocated for the initial (or new) transmission of a TB based on a configured uplink grant, or a CG PUSCH may be a CG PUSCH which is pre-allocated for the retransmission of a TB such as CG-based transmission in the NR-U (unlicensed) or NR shared spectrum.

According to the RRC message configuration, MAC CE indication and DCI of a base station (e.g., DCI activating a corresponding CG), a terminal may apply the examples of the present disclosure based on the first period and/or the second period for all activated CG(s) or may apply the examples of the present disclosure based on the first period and/or the second period only for a specific CG configuration index or a specific CG configuration.

Additionally or alternatively, according to the RRC message configuration, MAC CE indication and DCI of a base station (e.g., DCI activating a corresponding CG), a terminal may apply the examples of the present disclosure based on the first period and/or the second period only for initial (or new) transmission or may also apply the examples of the present disclosure based on the first period and/or the second period for a PUSCH retransmitting the TB of a CG PUSCH.

Additionally or alternatively, for the UL active time corresponding to an example of the second period, an on-duration timer for cell DTX/cell DRX/terminal DTX/terminal DRX may be configured. For example, a terminal may start or restart an on-duration timer aligned at the start time of the second period or the first CG PUSCH occasion of each CG periodicity. For this purpose, a base station may pre-configure the start time of the second period as a periodic time or may designate the start time of the second period to a terminal according to the indication of a specific MAC CE or DCI.

For example, an on-duration timer may be mapped only to one or a plurality of specific CG configuration index(es), or may be mapped only to one or a plurality of specific serving cell(s) where a CG is configured, or may be mapped only to at least one specific UL BWP(s) where a CG is configured, or may be mapped to all CG configurations. Here, a terminal may define/determine a period during which an on-duration timer is running as the UL active time of the second period described above. In other words, the active time of the second period may include the time during which a corresponding on-duration timer is running.

Additionally or alternatively, in order to allocate a retransmission resource for a PUSCH which retransmits the TB of a CG PUSCH, a separate DL retransmission timer may be configured for the DL active time corresponding to the second period which may receive DCI (including a dynamic uplink grant) (i.e., monitor a PDCCH) allocating a corresponding retransmission resource. For example, a terminal may start or restart a retransmission timer aligned at the start time of the second period or the first CG PUSCH occasion of each CG periodicity. For this purpose, a base station may pre-configure the start time of the second period as a periodic time or may designate the start time of the second period to a terminal according to the indication of a specific MAC CE or DCI.

For example, a retransmission timer may be mapped only to one or a plurality of specific CG configuration index(es), or may be mapped only to one or a plurality of specific serving cell(s) where a CG is configured, or may be mapped only to at least one specific UL BWP(s) where a CG is configured, or may be mapped to all CG configurations. In addition, since retransmission may be associated with the same HARQ process ID as initial (or new) transmission, a retransmission timer may also operate for each specific HARQ process ID. Here, a terminal may define/determine a period during which a retransmission timer is running as the DL active time of the second period described above. In other words, the active time of the second period may include the time during which a corresponding retransmission timer is running. A terminal may monitor DCI/a PDCCH or receive downlink transmission within the active time (or DL active time) of the second period.

Additionally or alternatively, for a TB previously transmitted through a CG PSUCH, when a terminal receives the retransmission resource (i.e., scheduling resource through a dynamic uplink grant for retransmission) of a corresponding TB through a PDCCH/DCI, the start time of the UL active time may be determined/defined according to the start time of a retransmission resource. Here, a terminal may configure a separate UL retransmission timer for the UL active time defining the second period. A terminal may start or restart an UL retransmission timer at the start time of a retransmission resource. In addition, a period during which an UL retransmission timer is running may be configured/defined to be included in the second period, and a terminal may perform uplink transmission within a corresponding period.

Additionally or alternatively, a base station may configure/define the second period during which uplink transmission of a terminal (or uplink reception of a base station) may be performed. The second period for this uplink transmission (or uplink reception) may or may not additionally include the time during which the above-described on-duration timer or UL retransmission timer is running without expiring.

Additionally or alternatively, a base station may configure/define the second period during which downlink transmission of a base station (or downlink reception of a terminal) may be performed. The second period for this downlink transmission (or downlink reception) may or may not additionally include the time during which the above-described DL retransmission timer is running without expiring.

### Embodiment 2

When (all of) the CG PUSCH resources are not (entirely) included within the active time of the second period for the uplink transmission of a terminal or the uplink reception of a base station, or when only a part of the CG PUSCH resources are included (or not included) within the active time of the corresponding second period, various examples for the uplink transmission operation of a terminal according to the configuration of a base station or as pre-defined are described below.

In addition, a terminal may receive DCI/a PDCCH (i.e., a dynamic uplink grant) that allocates a resource for uplink retransmission during the second period for the downlink transmission of a base station or the downlink reception of a terminal. In this case, when (all of) the retransmission PUSCH resources are not (entirely) included within the active time of the second period for the uplink transmission of a terminal or the uplink reception of a base station, or when only a part of the retransmission PUSCH resources are included (or not included) within the active time of the corresponding second period, various examples for the uplink transmission operation of a terminal according to the configuration of a base station or as pre-defined are described below.

### Embodiment 2-1

According to this embodiment, when a CG PUSCH resource or a retransmission PUSCH resource is not included or only a part thereof is included within the active time of the second period for the uplink transmission of a terminal or the uplink reception of a base station, a terminal may transmit a corresponding CG PUSCH or retransmission PUSCH.

For example, when all or a part of the CG PUSCH resources are included within the active time of the second period for the uplink transmission of a terminal or the uplink reception of a base station, a terminal operation may be defined to transmit a corresponding CG PUSCH and/or transmit the retransmission PUSCH of the same TB as a corresponding CG PUSCH.

For example, when all or a part of the CG PUSCH resources are not included within the active time of the second period for the uplink transmission of a terminal or the uplink reception of a base station, a terminal operation may be defined not to transmit a corresponding CG PUSCH and/or not to transmit a retransmission PUSCH (regardless of whether a base station receives the initial (or new) transmission of a terminal).

For example, when a terminal receives a PDCCH that is partially or entirely transmitted during the active time of the second period for the downlink transmission of a base station or the downlink reception of a terminal, even when all of the retransmission PUSCH resources allocated by a corresponding PDCCH are not included or only a part thereof is included (or a part thereof is not included) within the active time of the second period for the uplink transmission of a terminal or the uplink reception of a base station, a terminal operation may be defined to transmit a corresponding retransmission PUSCH.

For example, when a terminal receives a PDCCH that is partially or entirely transmitted during the active time of the second period for the downlink transmission of a base station or the downlink reception of a terminal, if all of the retransmission PUSCH resources allocated by a corresponding PDCCH are not included or only a part thereof is included (or a part thereof is not included) within the active time of the second period for the uplink transmission of a terminal or the uplink reception of a base station, a terminal operation may be defined not to transmit a corresponding retransmission PUSCH.

For example, when all of the retransmission PUSCH resources allocated by a PDCCH are not included or only a part thereof is included (or a part thereof is not included) within the active time of the second period for the uplink transmission of a terminal or the uplink reception of a base station, a terminal operation may be defined not to transmit a corresponding retransmission PUSCH during the corresponding active time, but to delay and transmit a corresponding retransmission PUSCH as in Embodiment 2-3 described below.

As an exception to the above-described examples, even when all or a part of the CG PUSCH resources and/or retransmission PUSCH resources are not included in the active time of the second period for the uplink transmission of a terminal or the uplink reception of a base station, a terminal may transmit a corresponding PUSCH according to an indication through the RRC configuration of a base station or DCI/MAC CE.

### Embodiment 2-2

According to this embodiment, when a CG PUSCH resource or a retransmission PUSCH resource is not included or only a part thereof is included within the active time of the second period for the uplink transmission of a terminal or the uplink reception of a base station, a terminal may skip a corresponding CG PUSCH or retransmission PUSCH, or disable a corresponding CG PUSCH or retransmission PUSCH, or consider a corresponding CG PUSCH or retransmission PUSCH to be suspended.

A terminal, for a skipped/disabled/suspended CG PUSCH, may resume CG-based transmission in a CG PUSCH resource located in the active time of the next closest second period.

Alternatively, for a skipped/disabled/suspended CG PUSCH, a terminal may resume CG-based transmission at the time when the next closest CG PUSCH resource among the CG PUSCH resources located in the active time of the second period arrives.

Alternatively, for a skipped/disabled/suspended CG PUSCH, a terminal may resume CG-based transmission at the time when the active time of the second period starts.

### Embodiment 2-3

According to this embodiment, when a CG PUSCH resource or a retransmission PUSCH resource is not included or only a part thereof is included within the active time of the second period for the uplink transmission of a terminal or the uplink reception of a base station, a terminal may delay a corresponding CG PUSCH or retransmission PUSCH to the time after the active time of the corresponding second period and transmit it.

For example, the delayed time may correspond to the time (e.g., an UL slot) determined according to a time offset configured by a base station based on the start time of the active time. Alternatively, the delayed time may correspond to the time (e.g., an UL slot) determined according to a time offset configured by a base station.

If a PUSCH resource corresponding to the delayed time does not belong to the second period, the corresponding PUSCH transmission may be dropped or may be delayed again to the different time after a time offset and transmitted.

For example, a time offset configured by a base station may be configured/indicated through RRC, MAC CE or DCI. For example, for a delay in a retransmission PUSCH, a time offset may be indicated through DCI that allocates a retransmission PUSCH. For example, for a delay in a CG PUSCH, a time offset may be indicated through DCI that activates a CG-based PUSCH transmission.

Additionally or alternatively, delayed PUSCH transmission may be performed in a CG PUSCH resource located in the active time of the next closest second period.

Alternatively, for the delayed time, delayed PUSCH transmission may be performed in the next closest CG PUSCH resource among the CG PUSCH resources located in the active time of the second period.

### Embodiment 2-4

According to this embodiment, when a CG PUSCH resource or a retransmission PUSCH resource is not included or only a part thereof is included within the active time of the second period for the uplink transmission of a terminal or the uplink reception of a base station, a terminal may invalidate or skip a corresponding CG PUSCH or retransmission PUSCH.

In this case, a terminal may retransmit a TB intended to be transmitted in an invalidated or skipped CG PUSCH or retransmission PUSCH through a valid CG PUSCH resource or retransmission PUSCH resource.

In various detailed examples of Embodiment 2 described above, different detailed examples may also be applied to a CG PUSCH and a retransmission PUSCH.

In various examples of the present disclosure described above, a terminal may stop or suspend a CG timer for a corresponding CG PUSCH at the start time of the second period for uplink transmission/reception or downlink reception/transmission. Afterwards, a terminal may start, restart or resume a corresponding CG timer at the end time of the second period.

In various examples of the present disclosure described above, an operation in which a PUSCH is not transmitted (i.e., skipped/disabled/suspended/invalidated, etc.) based on the active time of cell DTX and/or cell DRX and/or terminal DTX and/or terminal DRX may include that a TB to be transmitted is not generated in the MAC layer of a terminal (it includes not obtaining a TB (i.e., a MAC PDU) from a multiplexing and assembly entity by a HARQ entity for a (configured) uplink grant in a MAC layer), or that although a TB is generated/obtained in a MAC layer, the transmission/retransmission of a corresponding TB is not performed in a PHY layer (it includes not instructing a HARQ process to transmit/retransmit a TB or not instructing a PHY layer to generate the transmission/retransmission of a TB), and/or that although a TB is generated/obtained in MAC, a corresponding PUSCH resource is invalidated or de-prioritized in a PHY layer.

According to various examples of the present disclosure described above, an operation for whether a terminal transmits a PUSCH (i.e., a CG PUSCH and/or a retransmission PUSCH) according to whether a NES mode is applied or the DTX/DRX active time of a cell/a terminal is clarified, so unnecessary resource usage may be prevented in a base station and a terminal and accurate uplink transmission may be performed.

General Device to which the Present Disclosure May be Applied

FIG. 10 is a diagram which illustrates a block diagram of a wireless communication system according to an embodiment of the present disclosure.

In reference to FIG. 10, a first device 100 and a second device 200 may transmit and receive a wireless signal through a variety of radio access technologies (e.g., LTE, NR).

A first device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts included in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including commands for performing all or part of processes controlled by a processor 102 or for performing description, functions, procedures, proposals, methods and/or operation flow charts included in the present disclosure. Here, a processor 102 and a memory 104 may be part of a communication modem/circuit/chip designed to implement a wireless communication technology (e.g., LTE, NR). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a wireless device may mean a communication modem/circuit/chip.

A second device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts included in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including commands for performing all or part of processes controlled by a processor 202 or for performing description, functions, procedures, proposals, methods and/or operation flow charts included in the present disclosure. Here, a processor 202 and a memory 204 may be part of a communication modem/circuit/chip designed to implement a wireless communication technology (e.g., LTE, NR). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a wireless device may mean a communication modem/circuit/chip.

Hereinafter, a hardware element of a device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC, RLC, PDCP, RRC, SDAP). One or more processors 102, 202 may generate one or more PDUs (Protocol Data Unit) and/or one or more SDUs (Service Data Unit) according to description, functions, procedures, proposals, methods and/or operation flow charts included in the present disclosure. One or more processors 102, 202 may generate a message, control information, data or information according to description, functions, procedures, proposals, methods and/or operation flow charts included in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts included in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts included in the present disclosure may be implemented by using a firmware or a software and a firmware or a software may be implemented to include a module, a procedure, a function, etc. A firmware or a software configured to perform description, functions, procedures, proposals, methods and/or operation flow charts included in the present disclosure may be included in one or more processors 102, 202 or may be stored in one or more memories 104, 204 and driven by one or more processors 102, 202. Description, functions, procedures, proposals, methods and/or operation flow charts included in the present disclosure may be implemented by using a firmware or a software in a form of a code, a command and/or a set of commands.

One or more memories 104, 204 may be connected to one or more processors 102, 202 and may store data, a signal, a message, information, a program, a code, an instruction and/or a command in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. included in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. included in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefore, one or more transceivers 106, 206 may include an (analogue) oscillator and/or a filter.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

Here, a wireless communication technology implemented in a device 100, 200 of the present disclosure may include Narrowband Internet of Things for a low-power communication as well as LTE, NR and 6G. Here, for example, an NB-IoT technology may be an example of a LPWAN (Low Power Wide Area Network) technology, may be implemented in a standard of LTE Cat NB1 and/or LTE Cat NB2, etc. and is not limited to the above-described name. Additionally or alternatively, a wireless communication technology implemented in a wireless device 100, 200 of the present disclosure may perform a communication based on a LTE-M technology. Here, in an example, a LTE-M technology may be an example of a LPWAN technology and may be referred to a variety of names such as an eMTC (enhanced Machine Type Communication), etc. For example, an LTE-M technology may be implemented in at least any one of various standards including 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M and so on and it is not limited to the above-described name. Additionally or alternatively, a wireless communication technology implemented in a wireless device 100, 200 of the present disclosure may include at least any one of a ZigBee, a Bluetooth and a low power wide area network (LPWAN) considering a low-power communication and it is not limited to the above-described name. In an example, a ZigBee technology may generate PAN (personal area networks) related to a small/low-power digital communication based on a variety of standards such as IEEE 802.15.4, etc. and may be referred to as a variety of names.

A method proposed by the present disclosure is mainly described based on an example applied to 3GPP LTE/LTE-A, 5G system, but may be applied to various wireless communication systems other than the 3GPP LTE/LTE-A, 5G system.

1. A method comprising:
receiving, by a terminal from a network, information related to a configured uplink grant;
receiving, by the terminal from the network, information related to at least one of a cell discontinuous transmission (DTX) or a cell discontinuous reception (DRX) of a serving cell;
based on the serving cell being within a cell DRX active period, performing a new transmission of a transport block (TB) based on the configured uplink grant, wherein based on the serving cell not being in the cell DRX active period, the TB is not obtained in a medium access control (MAC) layer of the terminal;
on a physical downlink control channel (PDCCH), receiving, from the network, an uplink grant related to a retransmission of the TB; and
based on the serving cell being within the cell DRX active period, performing the retransmission of the TB based on the uplink grant related to the retransmission of the TB, wherein based on the serving cell not being in the cell DRX active period, the retransmission of the TB is not performed in a physical (PHY) layer of the terminal.

2. (canceled)

3. The method of claim 1, wherein:
the retransmission of the TB not being performed in the PHY layer is based on not instructing the retransmission of the TB to a hybrid automatic repeat request (HARQ) process associated with the retransmission of the TB, and the HARQ process not instructing the PHY layer to generate the retransmission of the TB.

4. The method of claim 1, wherein:
based on the serving cell being within a cell DTX active period, the PDCCH is monitored.

5. The method of claim 1, wherein:
based on the serving cell not being within a cell DTX active period, the PDCCH is not monitored.

6. The method of claim 1, wherein:
the uplink grant related to the retransmission of the TB includes information on an uplink resource for the retransmission of the TB based on the configured uplink grant.

7. (canceled)

8. The method of claim 1, wherein:
the cell DRX active period includes a time while an on-duration timer related to a cell DRX is running.

9. The method of claim 1, wherein:
based on the information related to the at least one of the cell DTX or the cell DRX of the serving cell, only a cell DTX is configured, only a cell DRX is configured, or both the cell DTX and the cell DRX are configured.

10. A terminal comprising:
at least one transceiver; and
at least one processor coupled to the at least one transceiver,
wherein the at least one processor is configured to:
receive, through the at least one transceiver, information related to a configured uplink grant from a network;
receive, through the at least one transceiver, from the network, information related to at least one of a cell discontinuous transmission (DTX) or a cell discontinuous reception (DRX) of a serving cell;
based on the serving cell being within a cell DRX active period, perform, through the at least one transceiver, a new transmission of a transport block (TB) based on the configured uplink grant, wherein based on the serving cell not being in the cell DRX active period, the TB is not obtained in a medium access control (MAC) layer of the terminal;
on a physical downlink control channel (PDCCH), receive, from the network through the at least one transceiver, an uplink grant related to a retransmission of the TB; and
based on the serving cell being within the cell DRX active period, perform, through the at least one transceiver, the retransmission of the TB based on the uplink grant related to the retransmission of the TB, wherein based on the serving cell not being in the cell DRX active period, the retransmission of the TB is not performed in a physical (PHY) layer of the terminal.

11. (canceled)

12. A base station comprising:
at least one transceiver; and
at least one processor coupled to the at least one transceiver,
wherein the at least one processor is configured to:
transmit, through the at least one transceiver, information related to a configured uplink grant to a terminal;
transmit, through the at least one transceiver, to the terminal, information related to at least one of a cell discontinuous transmission (DTX) or a cell discontinuous reception (DRX) of a serving cell;
based on the serving cell being within a cell DRX active period, receive, through the at least one transceiver, a new transmission of a transport block (TB) from the terminal based on the configured uplink grant, wherein based on the serving cell not being in the cell DRX active period, the TB is not obtained in a medium access control (MAC) layer of the terminal;
on a physical downlink control channel (PDCCH), transmit, to the terminal through the at least one transceiver, an uplink grant related to a retransmission of the TB; and
based on the serving cell being within the cell DRX active period, receive, through the at least one transceiver, the retransmission of the TB from the terminal based on the uplink grant related to the retransmission of the TB, wherein based on the serving cell not being in the cell DRX active period, the retransmission of the TB is not performed in a physical (PHY) layer of the terminal.

13-14. (canceled)
